(19) United States
(12) Patent Application Publication
(10) Pub. No.: US 2003/0229424 A1
(43) Pub. Date: Dec. 11, 2003

(54) AN AGRICULTURAL MACHINE FOR PERFORMING AN AGRICULTURAL OPERATION, IN PARTICULAR CROP PROCESSING

(75) Inventors: Theo Jan MIEDEMA, De Lier (NL); Karel van den BERG, Bleskensgraaf (NL)

Correspondence Address: HOWREY SIMON ARNOLD & WHITE, CITYPOINT, ONE ROPEMAKER STREET, LONDON, EC2Y 9HS, GB

(73) Assignee: LELY ENTERPRISES AG, Zug (CH)

(21) Appl. No.: 10/250,104

(22) Filed: Jun. 4, 2003

(30) Foreign Application Priority Data
Jun. 6, 2002 (NL) 1020794

(51) Int. Cl. G05D 1/00; G05D 3/00

(52) U.S. Cl. 701/1

(57) ABSTRACT

An agricultural machine for performing an agricultural operation, in particular crop processing. The agricultural machine is provided with a movable agricultural for performing the agricultural operation. The agricultural machine is provided with a detecting element for detecting a force acting on the detecting element and for emitting a detection signal depending on the detected force; with a protecting element for protecting the moving agricultural device, and with a displacing element for displacing, in dependence on the detection signal, the agricultural device and the protecting element relative to each other.

### CROSS REFERENCE TO RELATED APPLICATIONS

This application claims priority from Dutch patent application no. 1020794 filed Jun. 6, 2002, the contents of which are hereby incorporated by reference in their entirety.

### BACKGROUND OF INVENTION

1. Field of the Invention

The invention relates to the field of agriculture and to an agricultural machine for performing an agricultural operation, in particular crop processing, which agricultural machine being displaceable over an agricultural parcel and being provided with a movable agricultural device for performing the agricultural operation.

2. Description of the Related Art

Conventional agricultural machines require an operator to control the agricultural operation. A drawback of such agricultural machines is that the driver is principally responsible for the safety of the environment, in particular the safety of human beings and animals. When observing (possible) danger for the safety of the environment, the driver should activate, on the one hand, an emergency stop that stops the agricultural operation and should operate, on the other hand, the brakes of the tractor, so as to prevent damage or injury.

### SUMMARY OF INVENTION

According to the present invention there is provided an agricultural machine for performing an agricultural operation comprising an improved safety system.

For this purpose, according to the invention an agricultural machine for performing an agricultural operation, in particular crop processing, comprises a movable agricultural device for performing the agricultural operation, a detecting element for detecting a force acting on the detecting element and for emitting a detection signal in response to the detected force, a protecting element for protecting the moving agricultural device and a displacing element for displacing, in response to the detection signal, the agricultural device and the protecting element relative to each other. Due to the fact that a detecting element is used for operating the protecting element for protecting the movable agricultural device, in comparison with the known agricultural machine, the time between detecting a (possible) danger for the environment and protecting the agricultural device is shortened.

The invention can in particular be applied to an autonomous agricultural machine, i.e. an agricultural machine that does not require a driver for being moved.

In an embodiment of an agricultural machine according to the invention, the displacing element is suitable for bringing the protecting element into an active position in which the protecting element protects the movable agricultural device if the detection signal indicates that an object pushes against the detecting element, and for bringing the protecting element into an inactive position in which the protecting element releases the movable agricultural device if the detection signal indicates that the detecting element is no longer in contact with an object.

In an alternative embodiment of an agricultural machine according to the invention, the displacing element is suitable for bringing the agricultural device into an active position in which the protecting element protects the movable agricultural device if the detection signal indicates that an object pushes against the detecting element and for bringing the agricultural device into an inactive position in which the protecting element releases the movable agricultural device if the detection signal indicates that the detecting element is no longer in contact with an object.

As the weight to be displaced may be considerable, it is advantageous if the displacing element is a hydraulic displacing element.

In a further embodiment of an agricultural machine according to the invention the detecting element may comprise a mechanical detecting device.

In a still further embodiment of an agricultural machine according to the invention the mechanical detecting device may comprise a comb. Alternatively or additionally, the mechanical detecting device may comprise a roll with feelers. Alternatively or additionally, the mechanical detecting device may comprise a bracket with feelers. Alternatively or additionally, the mechanical detecting device may comprise an arm with a feeler. As feelers pressure sensors known per se may be used for example.

In an alternative embodiment of an agricultural machine according to the invention, the mechanical detecting device may be pivotably disposed on the agricultural machine. Here it is possible to emit a signal for operating the stopping element in dependence on the degree of pivoting.

In a further alternative embodiment of an agricultural machine according to the invention, the mechanical detecting element may be movably disposed on the agricultural machine. The agricultural machine comprises in particular a direction-of-travel-determining element for determining the direction of travel of the agricultural machine, the mechanical detecting device being movable with the aid of data from the direction-of-travel-determining element.

According to the present invention there is further provided a method of protecting a movable agricultural device for performing an agricultural operation, the movable agricultural device being provided on an autonomous agricultural machine, the method comprising: providing a protecting element for protecting the movable agricultural device, the protecting element and movable agricultural device being displaceable with respect to one another; providing a force detecting element mounted on the autonomous agricultural machine; detecting a force acting on the force detecting element and emitting a detection signal; and displacing the protecting element and movable agricultural device with respect to one another to a safe position in response to the displacement signal.

### BRIEF DESCRIPTION OF DRAWINGS

An embodiment of the invention will now be explained in further detail by way of example only with reference to the accompanying figures, in which:

FIG. 1 shows schematically in side view an autonomous agricultural machine in an embodiment of the invention.

### DETAILED DESCRIPTION

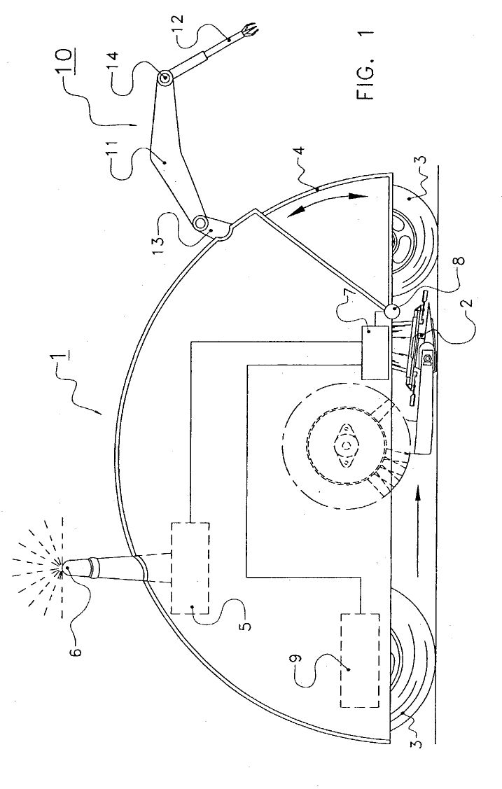

FIG. 1 shows schematically in side view an autonomous agricultural machine 1 in an embodiment of the invention. Although the invention will be described with reference to an autonomous agricultural machine, it will be obvious that the invention is not limited thereto. It is pointed out here that an autonomous machine, i.e. a machine that does not require a driver for being moved, but is movable with the aid of a position-determining system, is known per se and will not be set out here in further detail for the sake of simplicity of the description. Such an autonomous machine may for instance be of the type described in U.S. Pat. No. 4,769,700 the contents of which are hereby incorporated by reference in their entirety.

Various aspects of an autonomous machine are also disclosed in co-pending U.S. patent applications Ser. No. â [symbol] â [symbol] entitled “An Agricultural Machine for Performing an Agricultural Operation”; Ser. No. â [symbol] â [symbol] entitled “An Agricultural Machine for Performing Crop Processing” Ser. No. â [symbol] â [symbol] entitled “An Autonomous Agricultural Machine for Performing an Agricultural Operation, in Particular Crop Processing” Ser. No. â [symbol] â [symbol] entitled “A Device for Crop Processing” Ser. No. â [symbol] â [symbol] entitled “An Assembly for Performing Crop Harvesting” Ser. No. â [symbol] â [symbol] entitled “A System for and a Method of Performing a First and a Second Agricultural Operation on an Agricultural Parcel” Ser. No. â [symbol] â [symbol] entitled “An Assembly for Performing an Agricultural Operation, in Particular Crop Processing” and Ser. No. â [symbol] â [symbol] entitled “An Assembly and an Autonomous Agricultural Machine for Performing an Agricultural Operation, in Particular Crop Processing”, all of which claim priority in the Netherlands on Jun. 6, 2002, the contents of all of which are hereby incorporated by reference in their entirety.

The autonomous agricultural machine 1 is suitable for performing an agricultural operation, in particular crop processing, on a crop that is present on an agricultural parcel. In the embodiment shown the autonomous agricultural machine 1 is an autonomous mowing machine that mows crop that is present on the agricultural parcel by means of a mowing unit 2. Although several sorts of mowing units known per se may be used, in the embodiment shown the mowing unit 2 is constituted by mowing discs that are present on a cutter bar and are rotatable about an axis, which mowing discs are provided with mowing knives. It will be obvious that the agricultural machine may also be an agricultural machine for performing other crop processing operations.

The agricultural machine 1 is supported and displaced over the agricultural parcel by means of wheels 3. The autonomous agricultural machine 1 further comprises a mechanical protecting element 4, in the embodiment shown constituted by a cap, for protecting the movable agricultural device, in the embodiment shown the mowing unit 2. The agricultural machine further comprises a displacing element 7 for displacing the mowing unit 2 and the protective cap 4 relative to each other. In the embodiment shown, the displacement of the protective cap 4 takes place for example by rotation of the cap 4 about an axis of rotation 8. Here the displacing element 7 is preferably a hydraulic displacing element. It is pointed out that the invention is described with reference to an exemplary embodiment in which the protecting element is displaced relative to the agricultural device, but it will be obvious that a displacement of the agricultural device relative to a stationary protecting element can also be applied within the scope of the invention.

The agricultural machine further comprises a position-determining element 5, in the embodiment shown provided with an aerial 6, for determining the position of the autonomous agricultural machine 1 in the agricultural parcel by means of for example a GPS system. Alternative elements for determining position may also be used including for example DGPS, Galileo, or position determination by means of beacons, sonar and other acoustic means, optical devices and the like. The position-determining element 5 may also function as direction-of-travel-determining element for determining the direction of travel of the agricultural machine. Other devices may also be employed as direction-of-travel-determining elements, including local mechanical sensors on the machine which monitor the drive and steering systems and also machine mounted sensors which register relative motion between the machine and the ground.

In the embodiment shown in FIG. 1, the agricultural machine comprises a mechanical detecting device 10 constituted by an arm 11 that comprises a feeler 12. The arm 10 is rotatably disposed on the agricultural machine 1 via an axis 13. It is pointed out here that also other ways of movably disposing the detecting device on the agricultural machine are possible. The feeler 12 is further pivotably disposed relative to the arm 11 by means of a pivot axis 14. When the agricultural machine 1 is moving in the direction of an object, the feeler 12 touches the object at a given moment, as a result of which a pivoting movement in the pivot axis 14 and/or a rotation about the axis of rotation 13 occur(s). The degree of pivoting and/or rotation is a measure of the force exerted on the mechanical detecting device 10. A signal whose magnitude corresponds to the degree of pivoting is transmitted to the displacing element 7 which, in dependence on the magnitude of the signal, can interrupt the drive 9 of the wheels 3 for stopping the movement of the agricultural machine 1; if desired, the drive of the mowing unit 2 is interrupted as well. The protective cap 4 is brought by the displacing element 7 into the protecting, i.e. the active position. Although in this context reference has been made to an object, it is understood that within the scope of the present invention this may explicitly also include animate objects and living beings including human beings.

Depending on the direction of travel as determined by the direction-of-travel-determining element, the arm 11 can be rotated about the axis 13 in such a manner that said arm is positioned in the direction of travel for the purpose of correctly detecting objects.

The operation of the mechanical detecting device 10 can be checked regularly by colliding at a low speed with a known object in order to detect the reaction of the mechanical detecting device.

It will be obvious that the invention is not limited to the above-described embodiments. The mechanical detecting device may comprise for example a comb, a roll with feelers, or a bracket with feelers. The mechanical protecting element may further comprise for example other means, such as a box, a hatch, a canvas, a rolling door, an air bag of the like. As detecting device is further described a mechanical detecting element, but it will be obvious that electronic or electromagnetic detecting means can also be applied in the invention.

Many modifications in addition to those described above may be made to the structures and techniques described herein without departing from the spirit and scope of the invention. In particular, the devices and methods disclosed herein may also be used in conjunction with further features of the above-referenced co-pending applications. Accordingly, although specific embodiments have been described, these are examples only and are not limiting upon the scope of the invention.

1. An agricultural machine for performing an agricultural operation, the agricultural machine comprising:
a movable agricultural device for performing the agricultural operation;
a detecting element for detecting a force acting on the detecting element and for emitting a detection signal in response to the detected force;
a protecting element for protecting the moving agricultural device; and
a displacing element for displacing the agricultural device and the protecting element relative to each other in response to the detection signal.

2. The agricultural machine as claimed in claim 1, wherein the agricultural machine is an autonomous agricultural machine.

3. The agricultural machine as claimed in claim 1, wherein the displacing element brings the protecting element into an active position in which the protecting element protects the movable agricultural device if the detection signal indicates that an object pushes against the detecting element, and wherein the displacing element brings the protecting element into an inactive position in which the protecting element releases the movable agricultural device if the detection signal indicates that the detecting element is no longer in contact with the object.

4. The agricultural machine as claimed in claim 1, wherein the displacing element brings the agricultural device into a safe position in which the protecting element protects the movable agricultural device if the detection signal indicates that an object pushes against the detecting element, and wherein the displacing element brings the agricultural device into an operational position in which the protecting element releases the movable agricultural device if the detection signal indicates that the detecting element is no longer in contact with the object.

5. The agricultural machine as claimed in claim 1, wherein the displacing element comprises a hydraulic displacing element.

6. The agricultural machine as claimed in claim 1, wherein the detecting element comprises a mechanical detecting device.

7. The agricultural machine as claimed in claim 6, wherein the mechanical detecting device comprises a comb.

8. The agricultural machine as claimed in claim 6, wherein the mechanical detecting device comprises a roll with feelers.

9. The agricultural machine as claimed in claim 6, wherein the mechanical detecting device comprises a bracket with feelers.

10. The agricultural machine as claimed in claim 6, wherein the mechanical detecting device comprises an arm with a feeler.

11. The agricultural machine as claimed in claim 6, wherein the mechanical detecting device is movably disposed on the agricultural machine.

12. The agricultural machine as claimed in claim 11, wherein the mechanical detecting device is pivotably disposed on the agricultural machine.

13. The agricultural machine as claimed in claim 1, wherein the agricultural machine comprises a direction-of-travel-determining element for determining the direction of travel of the agricultural machine.

14. The agricultural machine as claimed in claim 11, wherein the agricultural machine comprises a direction-of-travel-determining element for determining the direction of travel of the agricultural machine and the mechanical detecting device is movable with the aid of data from the direction-of-travel-determining element.

15. A method of protecting a movable agricultural device for performing an agricultural operation, the movable agricultural device being provided on an autonomous agricultural machine, the method comprising:
providing a protecting element for protecting the movable agricultural device, the protecting element and movable agricultural device being displaceable with respect to one another;
providing a force detecting element mounted on the autonomous agricultural machine;
detecting a force acting on the force detecting element and emitting a detection signal; and
displacing the protecting element and movable agricultural device with respect to one another to a safe position in response to the displacement signal.
